(19) United States
(12) Patent Application Publication
(10) Pub. No.: US 2012/0197897 A1
(43) Pub. Date: Aug. 2, 2012

(54) METHOD OF DEFINING A COLLECTION OF DIGITAL MEDIA CONTENT

(75) Inventors: Mark Knight, Surrey (GB); Philip Sant, London (GB); Christopher Evans, London (GB); Matthew White, London (GB); Roy Stead, London (GB)

(73) Assignee: Omnifone Ltd., London, EN (GB)

(21) Appl. No.: 13/319,927

(22) PCT Filed: May 11, 2010
(86) PCT No.: PCT/GB2010/050771

§ 371 Date: Apr. 19, 2012

(30) Foreign Application Priority Data
May 11, 2009 (GB) 0907979.9
Dec. 9, 2009 (GB) 921560.9
Dec. 9, 2009 (GB) 0921561.7

(51) Int. Cl. G06F 17/30

(52) U.S. Cl. 707/740; 707/E17.046

(57) ABSTRACT

A method for defining a collection of digital media content for playback using a digital media player where (a) the collection is defined using specific criteria; and (b) the collection is not static but can alter or grow even after being made available to the digital media player; and (c) the said digital media files form a subset of a catalogue of digital media files available for the digital media player to play.

### BACKGROUND OF THE INVENTION

1. Field of the Invention

The present invention relates to a method of defining a collection of digital media content; it includes, in one embodiment, a method for implementing a media application on one or more types of digital media player computing devices, such that the user of the said devices is able to define and/or access media content which is aggregated according to defined criteria.

2. Description of the Related Art

Media players have long made use of playlists to aggregate media content into “playlists”, being parcels which are linked thematically in some fashion, for ease of playback. Such playlists have suffered from several major limitations, each of which is removed by the present invention.

A major limitation of the prior art is that the content of the playlist (the collection of tracks encapsulated within that playlist) has to be defined prior to its being made accessible to the media player. It is inherently static and not dynamic. Another major limitation, arising in part from the first, is that the number of tracks included in a playlist is necessarily limited.

The present invention resolves both of those historical problems by taking a different technical approach to the issues in disclosing mechanisms for using metadata to define “channels”, which may be thought of as adaptive playlists which are quasi-infinite in length—e.g. the playlist can alter and grow and is hence dynamic and not static.

### SUMMARY OF THE INVENTION

The present invention includes a method for defining and accessing media content via aggregated channels customised for a specific user, a specific device or device type or some combination thereof. Specifically, it is a method for defining a collection of digital media files for playback using a digital media player where (a) the collection is defined using specific criteria; and (b) the collection is not static but can alter or grow even after being made available to the digital media player; and (c) the digital media files form a subset of a catalogue of digital media files available for the digital media player to play.

The collection may be a ‘channel’, where a channel as defined in the present invention is a customised playlist which may be accessed by a user independently of any other playlists or music the user may be constructing using the client device. The channel may be ‘persistent’; ‘persistent’ is a term of art and is defined below.

Channel playlists as employed in the present invention differ from playlists employed in the prior art in that prior art playlists are finite in length and predefined, whereas channel playlists in the present invention are auto-generated based on supplied criteria, may be customised for a specific user and are generated as a persistent stream making them effectively of potentially infinite length—i.e. are not limited as to the number of digital media items that may be in the collection. The present invention may be implemented by a computer program; this may be a client-server, where the client is the digital media player and the server is a remote server linked to the digital media player over the internet and/or a wireless link.

### Definitions

For convenience, and to avoid needless repetition, the terms “music” and “media content” in this document are to be taken to encompass all “media content” which is in digital form or which it is possible to convert to digital form—including but not limited to books (fiction and non-fiction), magazines, newspapers, scientific papers, articles and other periodicals, video in the form of digital video, motion pictures, television shows (as series, as seasons and as individual episodes), images (photographic or otherwise), music, computer games and other interactive media.

Similarly, the term “track” indicates a specific item of media content, whether that be a song, a television show, an eBook or portion thereof, a computer game or any other category or discreet item of media content. A “digital media file” is a file that includes media content and also covers a digital media file descriptor; digital media files may be metadata or computational objects which describe, identify or correspond to digital media files.

The terms “playlist” and “album” are used interchangeably to indicate collections of “tracks” which have been conjoined together such that they may be treated as a single entity for the purposes of analysis, playback or recommendation.

The verb “to listen” is to be taken as encompassing any interaction between a human and media content, whether that be listening to audio content, watching video or image content, reading books or other textual content, playing a computer game, interacting with interactive media content or some combination of such activities.

The terms “user”, “consumer”, “end user” and “individual” are used interchangeably to refer to the person, or group of people, whose media content “listening” preferences are analysed and for whom recommendations are made.

The term ‘persistence’ or a ‘persistent stream’ refers to a stream of tracks which make up the “infinite playlist” or collection. So rather than the playlist being generated as a fixed size (as in the prior art) what happens with the present invention is that the defining criteria for the “playlist” are used to generate a set of tracks on request which fit the defined criteria. That set of tracks persists on the server and is used to server further requests (perhaps from other client devices) for tracks for that “channel” and additional tracks are added onto the end when the set of pre-generated tracks runs out.

Example: the client requests tracks for a channel. The server may generate a set of 100 tracks, say, using the channel's criteria and send, for instance, the first 20 of them to that client. Other clients may make similar requests and receives tracks from the same server-generated set. When the server receives a request for more tracks from the channel than it has in its previously-prepared list then it uses the channel criteria to generate additional tracks and append those to its set before serving the client request. Thus, as far as the client device is concerned the channel “playlist” appears to be infinite in size and its content (i.e. the tracks in it) persist over time, allowing the client to skip back and forth through the channel at will.

The term “recommendations” refers to media content items (“tracks”, “playlists” and “albums”) which are identified—using the mechanisms disclosed in the present invention, in GB 0921542.7 (or any applications related to that or claiming priority from that) or by any other compatible mechanisms—as matching or complementing the user's taste in media content.

The terms “device” and “media player” are used interchangeably to refer to any computational device which is capable of playing digital media content, including but not limited to MP3 players, television sets, home computer systems, personal computers, mobile computing devices, gaming consoles, eBook readers, handheld games consoles, vehicular-based media players or any other applicable device or software media player application operating on such a device.

### DETAILED DESCRIPTION

The present invention discloses, in one implementation, mechanisms for defining channels and for using those channels to provide customised “radio stations” to users of a digital media service.

### Channels

A channel may be a persistent customised playlist which may be accessed by a user independently of any other playlists or music the user may be constructing using the client device.

Media content may be categorised into separate “channels” based on one or more (i.e. a combination) of the following elements:
File format (such as DRM status).
Media type (video, music, fiction, non-fiction, books, eBooks, television shows, movies, magazines, newspapers, articles, scientific papers and so forth)
Zero, one or more metadata considerations (such as mood, era, genre, demographic metadata, specific artists or composers and so forth)
Zero, one or more metrics (such as chart channels, channels based on the popularity of track playback or purchase and so forth). Playback metrics may include one or more of user playback metrics or user purchasing data for one or more users of a digital media service. One or more users of a digital media service can be defined using demographic data concerning the users including one or more of user age, location, social group, device type(s), income, self-identified group labels or any other demographic data.
Editorial decisions (channels which are defined, directly or indirectly, by editors of the service within which that channel is utilised, or by some other nominated person or entity, such as channel selections chosen by a celebrity). In the preferred embodiment, editorial input is permitted to allow selection of tracks to be added to a channel, the said selection being made from a list of tracks which is generated using the other elements of the channel definition. This can be by direct selection by individuals or by the definition of additional criteria for a channel by the individuals.
Randomised (such as a random selection of music from the list available for a particular channel. For example, a channel defined by era ad metrics—such as music tracks popular in the 1960's—might be expected to be static unless some random or editorial element is, as in the preferred embodiment, used to vary its content over time)
One or more of recommendations of digital media content for the user, the availability of digital media content to the user. The availability of the digital media content may be calculated using one or more of the Digital Rights Management licenses for specific digital media items, the device or device type on which the user is presently accessing a service, the terms under which the user is accessing a digital media service, the content present on the device or the digital media playback capabilities of the device or any other mechanism for determining the availability of digital media items to the user
Any other criteria designed or calculated for the digital media files

In the preferred embodiment, each such channel has a name, a definition (metadata defining which items are included in that channel), an associated image for display within the user interface of a client devices and, in some example embodiments, a defined time period during which that channel is available to end users.

In addition, the preferred embodiment permits multiple definitions to be stored for each channel, for use with different client user interfaces and/or client devices. For example, a channel definition for a mobile device may incorporate limits on the number of items it may contain while the same channel may be defined with different, or no, limits with respect to a client device which is a home computer and may in addition specify a different range of permitted file formats for that device.

Similarly, a channel may have different associated imagery for thumbnail views as compared to views of an individual channel on the same client device or may store different images for use with different client devices.

Channel playlists as employed in the present invention differ from playlists employed in the prior art in that prior art playlists are finite in length and predefined, whereas channel playlists in the present invention are auto-generated based on supplied criteria, dynamic and not static and can hence be altered and extended after being made accessible to a media player, may be customised for a specific user and are generated as a persistent stream making them effectively of infinite length. The collection of digital media files may be provided to the digital media player in batches rather than as a single listing of all digital media files in the said collection; the digital media files included in any given batch is determined such that any given batch contains a random collection of the digital media tracks available within the collection of digital media tracks. The content of a batch of digital media files defined for the collection is recorded such that it may be retrieved, in whole or in part, by the digital media player while the collection is available to that digital media player.

The collection is capable of having an associated start date, before which the collection is unavailable to the user, and/or an expiration date or time period, after which the collection is unavailable to the user

The digital media player may present more than one collection to the user, whether individually or by grouping collections or by grouping groups of collections, and permits the user to choose which collection to play; the user is able to continue operating the device without interrupting playback of the collection on that device, such operations including but not being limited to the construction of playlists of digital media files and/or the definition of criteria for collections

### User-Specific Customisation

The inclusion or exclusion from channels of individual media items may be absolute or may be governed by a weighted percentage value—i.e. the collection criteria are assigned weightings, whether automatically or manually, to determine the relative contribution of that criterion to the digital media files included in the collection. The user is able to define, in whole or in part, the criteria used to create a given collection of digital media tracks For example, including music from a specific era of the 1960's with a weighted value of 25% will ensure that approximately 25% of the media items provided via the said channel will be those marked with the 1960's era in their metadata. Similarly, including a user profile identifier with a “previously played” weighting of 33% would ensure that that channel will be weighted, by 33%, towards items which that user has previously played.

In the preferred embodiment channel playlists are generated by the MusicStation® server and are customised according to the supplied criteria. The initially generated playlist is of a fixed length, measured either by the number of media items or by their total duration. That playlist is assigned a unique identifier and persists on the server such that it may be retrieved when created and/or at a later point.

Where the service within which the present invention is utilised permits the purchasing of tracks rather than, or in addition to, providing a subscription-based media content service then, in the preferred embodiment, the client device in the said service is able to provide end users with the option to purchase and download tracks, whether currently playing or otherwise visible within a channel listing.

### Synchronisation of Channels

The user's preference for particular “channels” may be used to prioritise the downloading of—and, in the preferred embodiment, to weight the recommendations for—new media content, in combination with one or more of the other user-device interaction analyses, such as those disclosed in GB 0921559.1 and any applications related to that or claiming priority from that.

In the preferred embodiment, such “channels” would be pre-populated with metadata and tracks where possible, the determination as to which are to be pre-emptively cached being based on one or more of the overall recommendations for the user, the type of network connection available, demographic data and editorial considerations, such as how to ensure that channels are populated evenly given the analysis already disclosed as to the user's listening preferences.

Channel-specific content is, in the preferred embodiment, stored securely on the client device using DRM protection appropriate to that device, and the synchronisation process for a channel includes the removal of stale channel content from the said device in order to free storage space for new channel content.

### Subscribing

In the preferred embodiment, the end user would utilise the user interface of their client device to search for available channels and to subscribe to those channels in which he is interested (and to unsubscribe from channels to which he has previously been subscribed). In one example embodiment, the said user is permitted to maintain different sets of subscribed channels, with zero, one or more such channels sets being device-specific, permitting the said user to subscribe to, for example, different channels on each of his registered devices.

Where a channel is subscribed to by the said user, that user's registered client devices are, in the preferred embodiment, automatically updated with new content consistent with that channel's definition for the said user and the said device. In the preferred embodiment, the said synchronisation occurs automatically in the background without requiring user intervention.

The initial selection of which channels to present—and, in the preferred embodiment, pre-subscribe to and/or pre-load with some or all of that channel's defined content—to a given user on a given device is, in the preferred embodiment, made in a similar manner, mutatis mutandis, as for the mechanism used to provide track recommendations on the service within which the channels are utilised. In another example embodiment, the said initial selection of channels is made manually.

Where a channel is unsubscribed by a given user, manually or automatically (due, for example, to a channel expiring) then any content which is specific to that channel is, in the preferred embodiment, removed from the user's device after a configurable interval, the said interval ensuring that a user who unsubscribes from and then re-subscribes to a given channel is not forced to immediately re-download that channel's previously-downloaded content. The said interval may, in one example embodiment, be configurable on a per-channel, a per-device, a per-device type, a per-user, a per-service or a global basis, or some combination thereof.

### Meta-Channels and Triggers

Where channels are themselves grouped into “meta channels” then the preferred embodiment would treat the said Meta channels similarly. In addition, in the preferred embodiment, empty channels are not displayed in the user interface.

Users who subscribe to a meta-channel may, in the preferred embodiment, be automatically subscribed to any new channels which are added to that meta-channel at any time. Time-restricted channels, for example, may be distributed in this manner.

In one example embodiment, all newly-created channels would be visible in one or more “New Channels” meta-channels, which may display all new channels or only those new channels which are related to channels to which the specific user is currently subscribed.

Similarly, the expiration of a time-limited channel may, in the preferred embodiment, trigger a notification to the user offering an alternative channel for subscription, the said offer either requiring manual acceptance by the end user or happening automatically in the background, according to a per-user, per-device, per-device type, per-channel, per-service and/or global configuration setting.

Radio stations

A radio station as defined in the present invention is a channel which may be accessed by a user independently of any other playlists, channels or music the user may be constructing or listening to using the client device.

Like channels, radio stations may be customized in a variety of ways. In the preferred embodiment radio stations are customisable by including or excluding digital media items according to one or more of the following criteria: mood, era, artist, genre, favourites (as defined by the user), recommendations (as determined by the recommendation engine utilized by the service within which the radio station is being utilised) or the listening history of either the user or the user's linked friends within the community of the said service.

Where the radio station playlist is retrieved at a point in time subsequent to its creation, the server in the preferred embodiment will return a playlist which takes account of the duration of the media items and the time since that playlist was last retrieved. For example in the case of a radio station playlist which was created or last retrieved ten minutes ago where the duration of the first three tracks is no more than ten minutes, retrieving that radio station playlist from the server will return a playlist which omits those first three tracks and appends additional tracks generated according to the same criteria originally used to generate that radio station playlist (that is, either an additional three tracks or track(s) of similar duration to those omitted will be appended to the returned radio station playlist, as per the definition of the fixed length of that originally generated playlist).

### User Interface

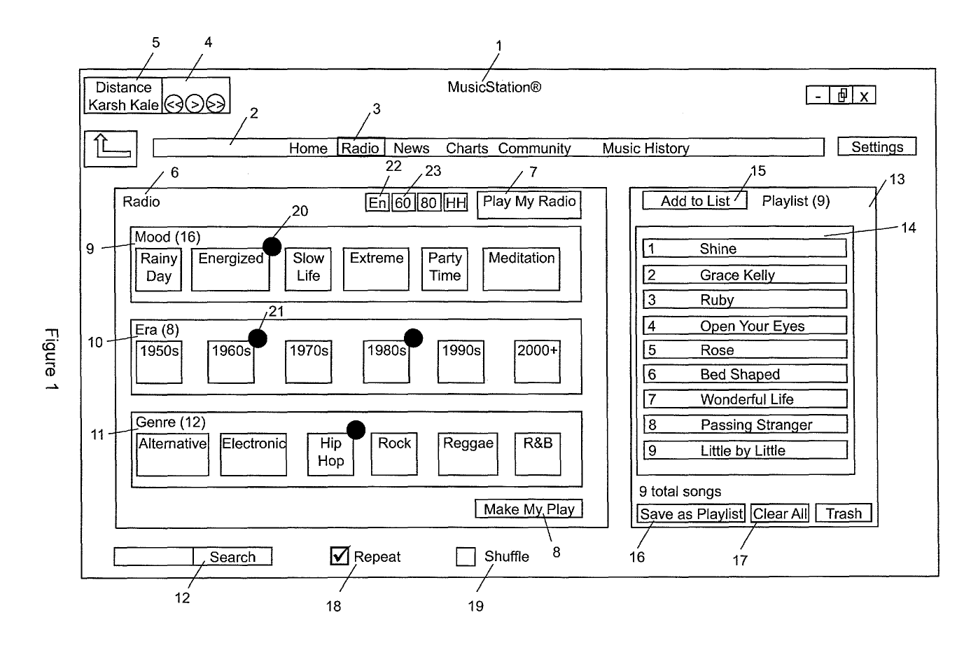

An example embodiment of the user interface is presented in FIG. 1. FIG. 1 is a schematic depiction of the screen of a PC running software that implements the present invention. A window 1, labelled MusicStation®, includes various icons and control regions etc. The major functions (Home, Radio, News, Charts, Community and Music History) are listed in band 2; the item for Radio 3 in this band 2 is shown selected. Selection of Radio 3 initiates the generation and/or selection of a customised channels. The track currently playing, a track called ‘Distance’ by a band called Karsh Kale, is listed in panel 5; conventional back/play/forward buttons are shown at 4. Panel 6 shows the major criteria used to define the radio channel or station. It includes various Moods at 9 (there are a total of 16 different moods to select, including ‘energised’, ‘slow life’ etc). Of these, only ‘Energised’ is shown selected, as indicated by the selection icon 20 and a matching icon 22. A further parameter, Era, is shown at 10: the user has selected the eras 1960's and 1980s.; these are confirmed with icon 23. Finally, the Genre parameter 12, has had the item ‘Hip Hop’ selected.

So in the example above, the major controls are those to select the parameters of the playlist—the selection of moods, eras, genres and so forth—presented in the central panel and the “Make My Play”8 and “Play My Radio” 7 buttons provided.

Each of the parameters may be selected and tuned —by adjusting the weighting—in the interface. In addition, such parameters as the weighting of the playlist towards, or against, tracks previously played by the current user may also be adjusted. Not shown above, but incorporatable into any given user interface, are controls which permit the user to fine-tune the playlist further in favour of, or against, more popular tracks and/or more mainstream music.

The “Make My Play” button 8, when clicked, generates a randomized radio station, while retaining some of the user's more general preferences—for example, the user's chosen weighting for/against popular, mainstream and previously played tracks could be retained while other settings, such as genre, mood and era, were randomized.

The “Play My Radio” button 7, when activated, causes the user's chosen radio station playlist to be played. Note that the radio station playlist is entirely distinct from the user's manually-created Lineup of tracks, which may be edited simultaneously. The manually-created Lineup is shown at 13, and lists nine tracks at 14. The lineup (called a ‘Playlist’ in FIG. 1) can be saved using button 16 and cleared using button 17. The user can search through the entire library (held on the server) using search button 12. Songs can be repeated, button 18 and shuffled, button 19.

In the example user interface above, the radio station playlist itself is not displayed on-screen. However, some embodiments of the user interface may present the user with a “Now playing on Radio” indication of the current track (e.g. at 5), together with a drop-down view of the radio station playlist and/or the facility to skip past individual radio station tracks (e.g. at 4).

The user's radio station, if playing, will continue playing in the background while the user navigates the rest of the user interface, and the currently playing track may be added to the user's Lineup, if desired, by clicking the “Add to List” button 15 in the example interface above.

In this example user interface, the weightings of each element are adjusted by right-clicking the individual elements and using a slider control (not shown) to adjust their weighting. Similar functionality may be provided via visible slider controls, manual entry text boxes, “dial” controls or equivalent user interface elements.

1. A method for defining a collection of digital media files for playback using a digital media player where (a) the collection is defined using specific criteria; and (b) the collection is not static but can alter or grow even after being made available to the digital media player; and (c) the digital media files form a subset of a catalogue of digital media files available for the digital media player to play.

2. The method of claim 1 where the criteria include one or more of the genre, digital media type, a “mood” label, artist(s), composer(s), editorial input, playback metrics or any other criteria defined or calculated for the digital media files.

3. The method of claim 2 where the digital media type is one or more of video, music, television shows, movies, fiction, non-fiction, books, magazines, eBooks, scientific papers, articles or any other category of digital media content.

4. The method of claim 2 where the editorial input involves the inclusion of tracks specifically chosen for inclusion in a given collection of digital media content, whether by direct selection by individuals or by the definition of additional criteria for a channel by the individuals.

5. The method of claim 2 where the playback metrics include one or more of user playback metrics or user purchasing data for one or more users of a digital media service.

6. The method of claim 5 where the one or more users of a digital media service are defined using demographic data concerning the users including one or more of user age, location, social group, device type(s), income, self-identified group labels or any other demographic data.

7. The method of claim 1 where the criteria includes one or more of recommendations of digital media content for the user, the availability of digital media content to the user or any other customisation criteria.

8. The method of claim 7 where the availability of the digital media content is calculated using one or more of the Digital Rights Management licenses for specific digital media items, the device or device type on which the user is presently accessing a service, the terms under which the user is accessing a digital media service, the content present on the device or the digital media playback capabilities of the device or any other mechanism for determining the availability of digital media items to the user.

9. The method of claim 1 where the collection of digital media files is provided to the digital media player in batches rather than as a single listing of all digital media files in the collection.

10. The method of claim 9 where the digital media files included in any given batch is determined such that any given batch contains a random collection of the digital media tracks available within the collection of digital media tracks.

11. The method of claim 1 where the content of a batch of digital media files defined for the collection is recorded such that it may be retrieved, in whole or in part, by the digital media player while the collection is available to that digital media player.

12. The method of claim 1 where any or all of the criteria, including the customisation criteria if applicable, are used in combination to define the said collection.

13. The method of claim 12 where the criteria are assigned weightings, whether automatically or manually, to determine the relative contribution of that criterion to the digital media files included in the collection.

14. The method of claim 1 where the user is able to define, in whole or in part, the criteria used to create a given collection of digital media tracks.

15. The method of claim 1 where the collection is capable of having an associated start date, before which the collection is unavailable to the user, and/or an expiration date or time period, after which the collection is unavailable to the user.

16. The method of claim 1 where the digital media player presents more than one collection to the user, whether individually or by grouping collections or by grouping groups of collections, and permits the user to choose which collection to play.

17. The method of claim 1 where the user is able to continue operating the device without interrupting playback of the collection on that device, such operations including but not being limited to the construction of playlists of digital media files and/or the definition of criteria for collections.

18. The method of claim 1 where the digital media files are metadata or computational objects which describe, identify or correspond to digital media files.

19. The method of claim 1 where the digital media player is a software application operating on a computing device and the computing device is one or more of a personal computer, a gaming console, a television, an eBook reader, a mobile computing device or any other computing device.

20. The method of claim 1 where the collection is not fully defined prior to being made available to the digital media player but can be dynamically altered or grown.

21. The method of claim 1 where the defining of the collection is done automatically

22. The method of claim 1 where the collection is a persistent playlist.

23. The method of claim 1 where the collection is a persistent stream.

24. The method of claim 1 where the collection is customised for a specific end user.

25. The method of claim 1 where the collection is not limited as to the number of digital media items which it may contain.

26. A computer program adapted to perform the method of claim 1.

27. A digital media player including a computer program adapted to perform the method of claim 1, or operating as the client element in a client-server program adapted to perform the method of claim 1.
